(19) United States
(12) Patent Application Publication
(10) Pub. No.: US 2026/0292458 A1
(43) Pub. Date: Sep. 24, 2026

(54) LOW-POWER SLOTTED RECEIVER FOR BLUETOOTH

(71) Applicant: Intel Corporation, Santa Clara, CA (US)

(72) Inventors: Yoav EISENBERG, Yehud-Monosson (IL); Avishay Friedman, Petach Tikva (IL)

(21) Appl. No.: 19/087,000

(22) Filed: Mar. 21, 2025

(51) Int. Cl. H04W 4/80; H04L 27/14

(52) U.S. Cl. CPC H04W 4/80; H04L 27/14

(57) ABSTRACT

Various embodiments herein relate to a wireless communication device that includes receiver circuitry configured to receive a wireless signal, a first filter configured to generate a first filtered signal from an output of the receiver circuitry, and a second filter configured to generate a second filtered signal from the first filtered signal. The first filtered signal and the second filtered signal have different sampling rates. The device also includes a Gaussian Frequency Shift Keying (GFSK) detector coupled to the first filter and the second filter, and control circuitry coupled to the GFSK detector and the receiver circuitry. The control circuitry is configured to switch the receiver circuitry between an on-period and an off-period based on an output from the first GFSK detector and the second GFSK detector. Other embodiments may be described and/or claimed.

### BACKGROUND

Various embodiments generally may relate to the field of wireless communications. With the proliferation of wireless communication devices, such as wireless peripheral devices, receiver devices (e.g. smartphones, laptops, etc.) may increase their packet detection accuracy by scanning more frequently. For example, there may be a number of Bluetooth® Low Energy (BLE) peripheral devices, such as home automation sensors and actuators (e.g., smart lights and alarm systems), sports sensors, wearable devices (e.g., wireless headsets), hearing aids, smart watches, and the like, all advertising on only three designated frequencies in the 2.4 GHz industrial, scientific and medical (ISM) radio band, leading to more advertising packet collisions. Furthermore, proximate interference caused by other 2.4 GHz devices (e.g., WiFi and some LTE bands) may further degrade advertiser packet detection. More frequent scanning by the wireless receiver device may avoid at least some of these issues but may also lead to additional power and battery consumption on the receiver device.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a wireless communication environment, according to aspects of the present disclosure.

FIG. 2 depicts a timing diagram showing operation of a slotted receiver scheme, according to an embodiment.

FIG. 3 illustrates graphs of absolute value, phase and unwrapped phase over time for a noise or non-GFSK signal, according to aspects of the present disclosure.

FIG. 4 illustrates a block diagram of a receiver system for detecting GFSK-modulated signals, according to an embodiment.

FIG. 5 is a diagram of an example slotted Rx state machine for use in the system.

FIG. 6 depicts a graph of phase difference variance versus a sample index, according to aspects of the present disclosure.

FIG. 7 shows a graph of phase difference variance versus sample index, in different Signal-to-Noise (SNR) ratios, according to an embodiment.

FIG. 8 depicts cumulative distribution function curves for Gaussian Frequency Shift Keying (GFSK) detection metrics at different signal-to-noise ratios (SNR), according to aspects of the present disclosure.

FIG. 9 shows cumulative distribution functions of GDET variance metrics, according to an embodiment.

FIG. 10 depicts a graph showing the phase difference variance metric values in the slotted Rx scan flow for the HBF0 signal plotted against a sample index, according to aspects of the present disclosure.

FIG. 11 presents a graph showing BLE packet error rate (PER) versus signal-to-noise ratio (SNR) performance curves for different receiver configurations, according to an embodiment.

FIG. 12 shows the expected power saving using the slotted Rx scan operation, according to an embodiment.

FIG. 13 depicts graphs showing packet error rate (PER) versus signal-to-noise ratio (SNR) for different off-periods in a Bluetooth Low Energy (BLE1M) system, along with the expected power save in each case, according to aspects of the present disclosure.

FIG. 14 depicts a graph showing detection ratio versus signal-to-noise ratio (SNR) performance for different off-periods in a wireless system, according to an embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). Unless used differently herein, terms, definitions, and abbreviations may be consistent with terms, definitions, and abbreviations defined in 3GPP TR 21.905 v16.0.0 (2019 June).

Operating systems (OS), such as Windows, provide out-of-the-box (OOTB) Bluetooth (BT) functionality that supports three primary use cases: Low Energy (LE) Scan, Page Scan, and Advertisement. LE scanning is a process where a device actively listens for BLE advertisements from nearby devices. Page Scan is a legacy BT where a device periodically listens for connection requests from other BT devices. Advertisement is a broadcasting mechanism where devices periodically transmit small packets of data, and in the context of operating systems, the OS can configure devices to advertise their presence and capabilities.

These three primary use cases continuously run whether a user is active (e.g., Hands-Free Profile (HFP), Human Interface Device (HID)) or not, and have a significant impact on BT scan power consumption. In Windows, the LE SCAN interval is 367 ms for 10% (aka 36.7 ms) and LE Scan percentage may likely increase in the future. Page Scan interval is 640 ms for 2×11.25 ms. For example, in common devices, the LE Scan accounts for 40% (4.4 mW/11 mW) of the OOTB BT scan power, and the Page Scan accounts for 15% (1.65 mW/11 mW) of the OOTB BT scan power.

A prior approach described a time slotted scan receiver in which a BLE slotted scan is performed based on energy detection and/or a parallel hypothesis correlator to increase packet detection accuracy and lower overall power consumption. This approach detects the presence of signal energy, while also reducing the false alarm rate by identifying the preamble pattern (which is a fixed, known pattern, such as AAC). The approach uses a sliding window correlator concept, where multiple timing phase hypotheses can be tested based on when the scan window was opened relative to the start time of advertisement packet transmission, a portion of which falls within the receiver's scan window. In addition, a short scan can be implemented in the analog circuit to speed up the settling time of the analog circuitry of the RF processing circuitry caused by the on/off cycling, such that only ~1 μs (or at most 2 bits) are lost due to these transient effects. This approach uses power detection for the BLE receiver on/off decision using multi-symbol parallel preamble detection, which involves the following three phases: (a) performing parallel cross-correlation for all possible valid preamble patterns at 13× or 8× oversampling ratio; (b) compensating the cross-correlation results with power to obtain the signal-to-noise ration (SNR); and (c) finding the maximum value out of the cross-correlation results, and comparing the maximum value with an SNR-based threshold. If a preamble pattern is detected at, then the receiver circuitry is held in the On-period.

While this energy detection approach works for its intended purpose, it may be prone to false alarms due to interference like Wi-Fi, LTE, or DECT, as any wireless energy will breach its threshold, moreover, the energy detection approach requires calibration of the noise level in order to set the threshold correctly. In addition, the energy detector variance is high, and very low SNR signals are not detectable.

In addition, the approach of using multiple parallel hypothesis correlators is very cumbersome and power-hungry as it requires parallel cross-correlation for all possible preamble patterns at 13× or 8× oversampling ratio. This approach also requires relaxing the Bluetooth Core Specification (BT Core Spec) (Bluetooth Qualification (BQB) certification requirements), i.e., removing the no-error in the AAC rule for advertising channels in the BT Core Spec.

According to the disclosed implementations, a low-power slotted BT receiver is provided that reduces BT scan (receive) power requirements, particularly for LE and Page Scans, by switching the receiver's RF and digital domains ON/OFF based on a low-latency phase detector that discriminates between a signal and noise. This allows long Off-periods which reduce power consumption without significant performance degradation.

In further detail, the slotted BT receiver includes a fast and simple phase detector to quickly detect if a signal of interest (e.g., BT) exists at the receiver. By using the underlying characteristics of Gaussian Frequency Shifted Key (GFSK) modulated signals that are used in Bluetooth (BT), a low latency phase detector, referred to herein as GFSK Detector (GDET), provides reliable discrimination between noise and BT signals. If the GFSK detector does not detect any signal of interest, i.e. a GFSK signal, at the receiver, it turns off the radio frequency (RF) and the receiver's Digital Front End (DFE) to save power consumption. After a configurable Off-period, the entire receive chain is turned ON, and a new acquisition session is initiated. There is a tradeoff between the length of the Off-period and the packet miss-detection probability. As the Off-period increases, a larger percentage of the scan power is preserved. However, it also results in a higher probability of missing the BT packet, since the receiver is “blind” during the Off-period and might miss the beginning of the Access Address (AAC).

To distinguish this invention approach and the prior correlator-based approach, an artificial BT signal with a non-compliant preamble of, e.g., all ones, would be rejected by the correlator-based approach since such a signal is not a valid Bluetooth preamble pattern. However, the disclosed implementations will not reject such a signal and instead receive it as a valid signal since such a waveform possesses the general GFSK property that the GFSK detector of the disclosed embodiments is seeking.

In addition, the GFSK detector approach is resilient to timing and frequency offset, has low complexity, and is power efficient. The GFSK detector also does not require any change to the current BT Special Interest Group (BT SIG) BQB tests, meeting the required standards for compatibility and performance. The disclosed implementations also allow a BT modem to consume significantly less power than conventional BT modems, improves battery life of products incorporating the BT modem, and contributes to reducing energy loss across technology platforms that include BT modules, without any impact on user experience. In some implementations, a low power GFSK BT receiver is provided that is controlled by a slotted Rx scan algorithm that alternates BT receiver operation (RF and Digital) between ON and OFF time slots. The BT receiver achieves comparable performance (Packet Error Rate) to a 100% duty cycle receiver, with significant power consumption reduction (saving ~65% of power) by employing an innovative GFSK phase detector that exploits the GFSK waveform properties.

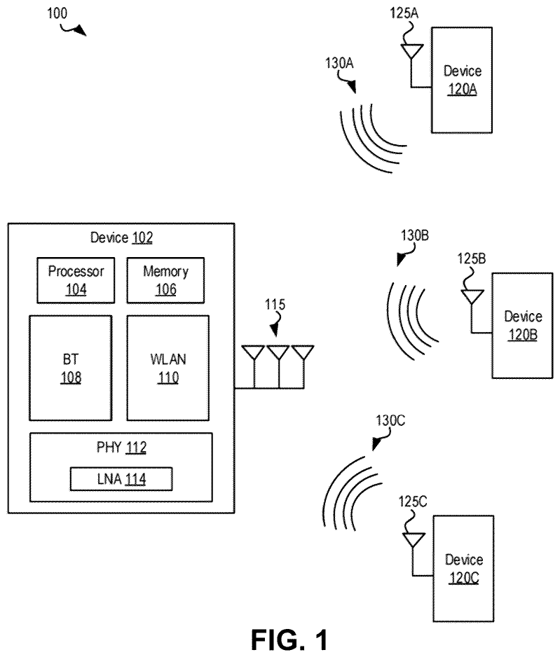

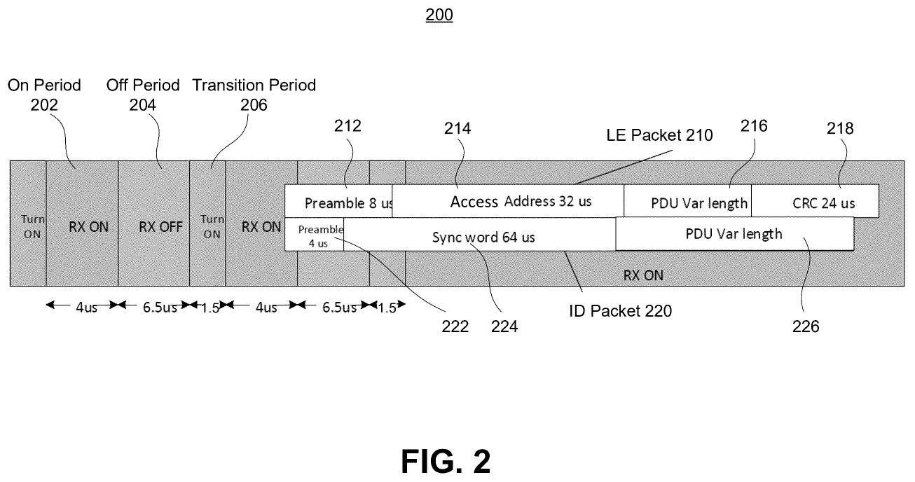

FIG. 1 illustrates a wireless communication environment, according to aspects of the present disclosure. The wireless communication environment 100 may include a central device 102 and multiple peripheral devices 120 (120A, 120B, and 120C) according to some embodiments. In the example shown, the peripheral devices 120 are wirelessly transmitting advertising information 130 (130A, 130B, and 130C) to a central wireless communication device 102 (central device 102) via their antennas 125 (125A, 125B, and 125C). In some cases, the advertising information 130 is transmitted on a frequency within the 2.4 GHz industrial, scientific and medical (ISM) radio band. The advertising information may include information used to establish wireless communication between the central device 102 and the particular device 120 sending the advertising information, information about the particular device 120 (e.g., information regarding a sensor of the device 120), or another type of information. In some embodiments, the advertising information 130 may include a packet formatted similar to one of the example packet formats shown in FIG. 2. In certain embodiments, the advertising information 130 may include an advertising packet formatted according to the Bluetooth® Low Energy (BLE) protocol, an inquiry or paging packet formatted according to the Bluetooth® Basic Rate (BR) protocol, a packet formatted according to an IEEE 802.11 protocol (e.g., WiFi), or a packet formatted according to another type of wireless communication protocol.

The example device 102 includes a processor 104 (e.g., a central processing unit (CPU), application processing unit (APU), another type of data processing apparatus, or a combination thereof), memory 106 (e.g., random access memory (RAM), read only memory (ROM), or a combination thereof), Bluetooth® circuitry 108 (e.g., including a Bluetooth baseband processor, radio integrated circuit, front-end module, and optionally at least one antenna), an wireless local area network (WLAN) circuitry 110 (e.g., a WLAN circuit card or WLAN system including a WLAN baseband processor, radio integrated circuit, front-end module and optionally at least one antenna). Antennas 115 are configured to transmit or receive wireless signals for communication with the Bluetooth circuitry and/or the WLAN circuitry. Each of the Bluetooth circuitry 108 and WLAN circuitry 110 may include physical layer (PHY) circuitry and Medium Access Control (MAC) circuitry. The device 102 may also include additional physical layer (PHY) circuitry 112 for performing low-level signal processing for wireless communication by one or more RF processing circuitries of Bluetooth circuitry 108 and WLAN circuitry 110. The PHY circuitry 112 may include one or more digital circuits, analog circuits, or other hardware for performing the low-level signal processing. For instance, in the example shown, the PHY circuitry 112 includes a low noise amplifier (LNA) 114 for amplifying signals received by one or more of the antennas 115 of the device 102. In some instances, the PHY circuitry 112 may receive low-level signals from one or more of the antennas 115, process the signals, and provide the processed signals to one or more of the RF processing circuitries of Bluetooth circuitry 108 and WLAN circuitry 110.

Each of the devices 120 may be implemented in a similar manner to the device 102. For example, each of the devices 120 may include a processor, memory, network connectivity mechanism (such as the Bluetooth circuitry or WLAN circuitry), and PHY circuitry similar to processor 104, memory 106, RF processing circuitries, and the PHY circuitry 112, and the device 102. The devices 120 may include additional or fewer components than those of the device 102. For instance, the devices 120 may only include one network connectivity mechanism rather than the multiple network connectivity mechanisms of the device 102. In addition, the devices 120 may include certain circuitry not included on the device 102. As one example, the devices 120 may include particular sensor circuitry (e.g., accelerometers, temperature sensors, etc.). The devices 120 may be implemented in another manner as well.

To improve the detection statistics of the advertising information 130 (e.g., of BLE or BR advertisements), the device 102 may be configured to scan for the advertising information 130 relatively often. However, more frequent scanning may substantially increase power consumption on the device 102, negatively impacting battery life

According to the disclosed implementations, the continuous BT scan is replaced with a “slotted Rx” scan, i.e., a scan that alternates between ON and OFF slots of time. The time-slotted scanning technique may be used by device 102 to increase packet detection accuracy while achieving lower overall power consumption by the wireless circuitry.

According to the disclosed embodiments, the slotted Rx scan incorporates a GFSK detector (GDET) coupled to the receiver circuitry and configured to analyze a phase property of the wireless signal during a short on-period, and generate a detection signal based on the analyzed phase property. In one embodiment, a first filter generates a first filtered signal from an output of the receiver circuitry, and a second filter is configured to generate a second filtered signal from the first filtered signal, where the first filtered and second filtered signal have different sampling rates. In certain aspects, the GFSK detector comprises first and second GFSK detectors coupled to the first filter and the second filter, respectively. Control circuitry is coupled to the GFSK detector and the receiver circuitry and is configured to switch the receiver circuitry between the on-period and an off-period based on the detection signal output from the first and second GFSK detectors.

The time-slotted scanning technique utilizing a GFSK detector cycles one or more components of the RF processing circuitries (e.g., receiver circuitry, such as the receiver circuitry implemented in the Bluetooth circuitry 108) in response to detection of BT signals to conserve power. In certain aspects, the GDET is configured to classify the wireless signal as a BT signal responsive to determining the wireless signal comprises the GFSK property. When this is the case, the receiver circuitry is kept operational to receive the whole BT packet, and synchronization flow for detecting the access address may be initiated, e.g., using a correlator. In case no valid BT signal exhibiting the GFSK property is detected, the GDET is further configured to cause the receiver circuitry to shut down or turn off for an Off-period, during which the power for the receiver's RF and the Digital Front End (DFE) is conserved. In certain aspects, a duty cycle of the On/Off-periods of the slotted Rx time scheme is configurable, with a trade-off between power save and detection performance.

In addition, in some embodiments, components external to the RF processing circuitry (e.g., an eLNA or other PHY circuitry external to the RF processing circuitries 108, 110) may be synchronously cycled between an On-period and an Off-period along with the receiver circuitry. For instance, in some devices, power consumption associated with scanning for devices may be dominated by external low-noise amplifiers (eLNA), and so, by cycling the eLNA on/off in addition to the receiver circuitry, greater power savings may be achieved.

FIG. 2 illustrates an example a timing diagram of a slotted Rx time scheme 200 according to some embodiments. The examples show a relative timing of a signal comprising an LE advertisement packet 210 or a BR ID packet 220 being incident at the receiver circuitry within the receiver device (e.g., one or more components of the Bluetooth circuitry 108 of FIG. 1) or other circuitry (e.g., the LNA 114 of FIG. 1) according to the slotted RX time scheme 200. In these examples, the LE packet 210 and the ID packet 220 use binary GFSK modulation, in which a 1 bit transmission is 1 microsecond (μs) in duration.

Each example shows that the receiver circuitry cycles between an On-period 202 and an Off-period 204 until a component of the LE packet or the ID packet 220 is detected by the GFSK detector. In certain aspects, the slotted Rx time scheme 200 in which the receiver is circuitry cycled between an On-period 202, an Off-period 204, and a transition-period 206. In this example, the On-period 202 may be 4 μs, the Off-period may be 6.5 μs, and the transition-period may be 1.5 μs. However, other on/off-periodicities may be used as well, such as 3-6 μs for the On-period 202, 4-12 μs for the Off-period 204, and 0.5-2.5 μs for the transition-period 206.

During On-periods, the GFSK detector is configured to detect if an incoming signal comprises GFSK properties, indicating a valid BT signal. Two example types of valid BT signals packets that may be received are shown: an LE packet 210 used for Bluetooth Low Energy (BLE) and ID packet 220 used in Bluetooth Classic (BR/EDR), both used for device discovery and connection establishment.

The LE packet 210 may comprise a preamble 212 that consists of 1 octet (i.e., 8 bits), an access address 214 that consists of 4 octets (i.e., 32 bits), a protocol data unit (PDU) 216 that is of variable length and consists of 2-257 octets (i.e., 16-2056 bits), and a cyclic redundancy check (CRC) that consists of 3 octets (i.e., 24 bits). The preamble 212 may include information used for automatic gain control training, frequency synchronization, or timing estimation at the receiver device. The access address 214 may include information indicating that the packet 210 is an advertising packet (e.g., if sent in an advertising channel), or link layer information (e.g., if sent in a data channel). The PDU 216 may include information for processing or analysis by the receiving device. The PDU 216 may include a header and payload, with the header indicating a packet type, a purpose of the packet, or other information about the packet 210, and the payload may include payload data for processing. The CRC 218 may include information computed by the transmitting device based on the contents of one or more of the preamble 212, the access address 214, and the PDU 216, and may be used by the receiving device to detect errors in reception or processing of the packet at the receiver side. In some instances, the format of packet 210 may be used in an advertising packet of the BLE protocol.

For BR, the ID packet 220 consists of two main components: a preamble 222 (4 bits), and a sync word 224 (64 bits), which together form an Access Code. The ID packet 220 may also include a PDU 226 (var. length) for data. The preamble 222 may be used for frequency synchronization at the receiver, may allow the receiver to perform automatic gain control, and may help in estimating symbol timing. The sync word may be derived from a Bluetooth Device Address (BD_ADDR), may help in identifying the piconet or the specific device, depending on whether it's a Channel Access Code (CAC) or Device Access Code (DAC), and may enable the receiver to synchronize with the incoming transmission and detect the start of the packet.

As shown in FIG. 2, in some cases, the receiver circuitry may be turned on after the packet transmission has already started but somewhere within the preamble, address, or PDU fields of either the BLE packet 210 or the ID packet 220. This is different than conventional scanning in receiver devices in which the beginning of the preamble is typically received after the receiver circuitry has already opened its scan window.

With the time-slotted scanning technique utilizing a GFSK detector, one or more components of the RF processing circuitries (e.g., receiver circuitry) are kept on in response to the GFSK detector detecting the presence in the received signal of GFSK properties, indicating a valid BT packet, including, but not limited to, the types of packets described above.

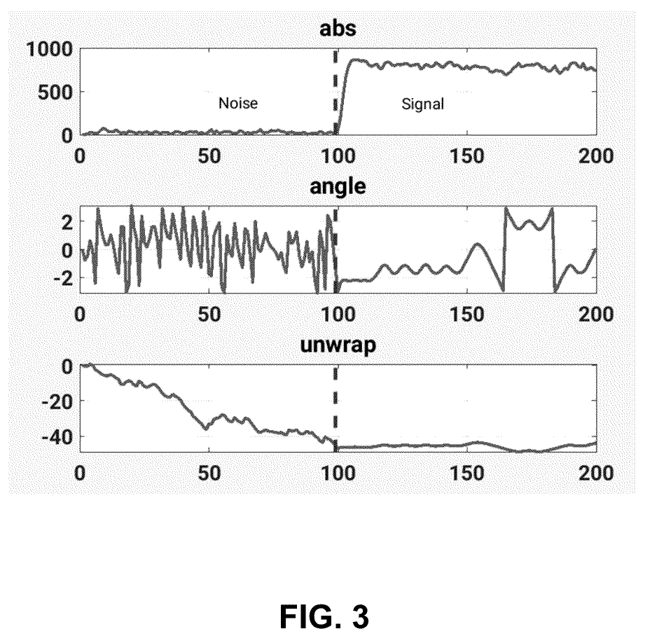

GFSK signals include properties such as smooth phase and are thus expected to exhibit very low phase difference variance compared to white noise and WiFi signals, which have very high phase difference variance, as shown in FIG. 3.

FIG. 3 illustrates graphs of absolute value, phase and unwrapped phase over time for a noise or non-GFSK signal and a GFSK-modulated signal using the functions abs, angle, and unwrap. The example noise or non-GFSK signal is shown on the left side of the graphs, and the example GFSK signal is shown on the right side of the graphs. The abs function calculates the magnitude or absolute value of the signals and represents the signal's amplitude, disregarding phase information. The angle function computes the phase angle of the signals and extracts phase information, while the unwrap function is used to correct phase angle discontinuities to provide a continuous phase curve. As depicted, the magnitude of the GFSK signal is significantly higher than the noise signal. The angle and unwrap graphs show that the GFSK signal also exhibits low variance, while the non-GFSK signal exhibits high variance.

This phenomenon can be exploited by classifying a received wireless signal with a low variance property as a GFSK signal or a valid Bluetooth signal, and classifying the wireless signal with a high variance property as a non-GFSK signal. A threshold which discriminates between GFSK and non-GFSK signals has been found for Basic Rate (BR) and Bluetooth Low Energy (BLE) BT signals, as described below.

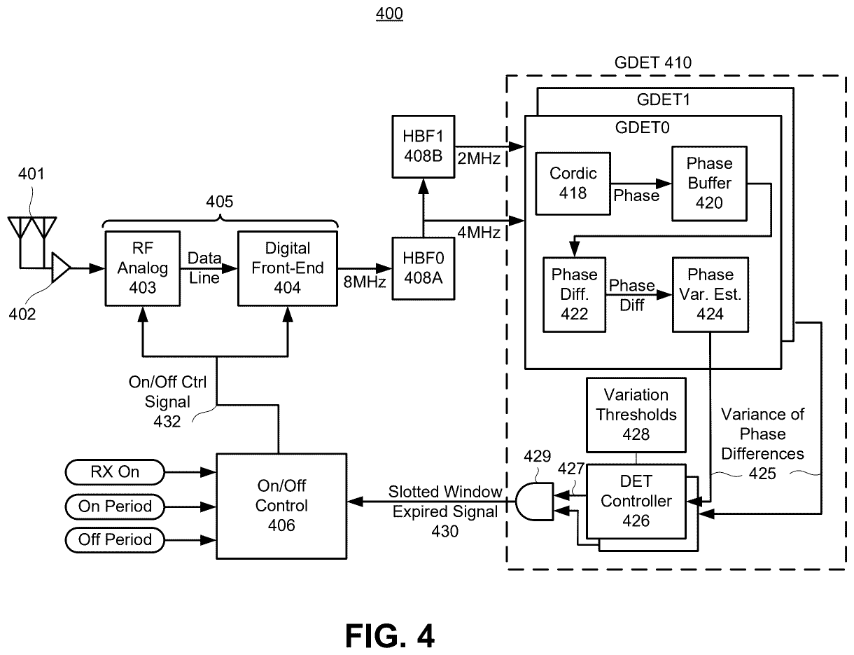

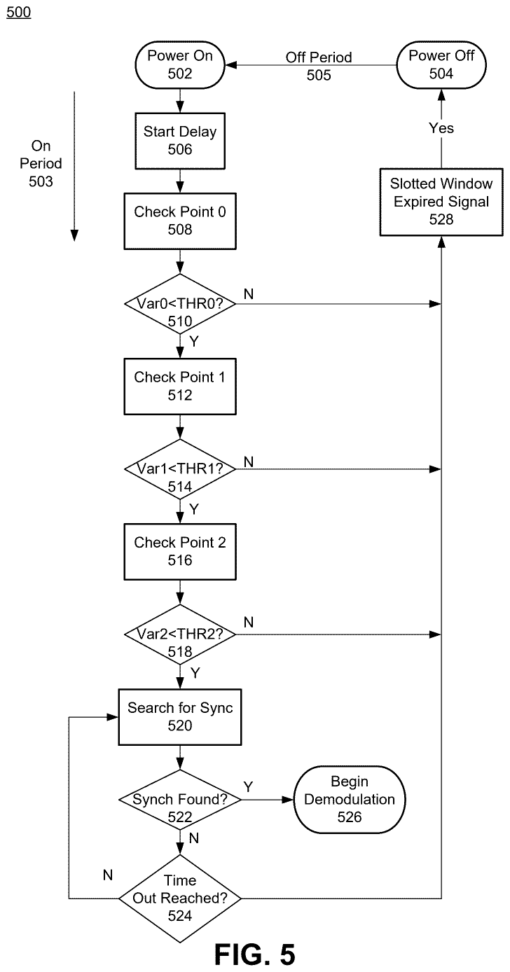

FIGS. 4 and 5 are diagrams of an example system 400 for implementing a time-slotted scanning technique on a wireless receiver device according to some embodiments. In particular, FIG. 4 is a diagram of an overall architecture of the system 400, and FIG. 5 is a diagram of an example slotted Rx state machine for use in the system 400 according to some embodiments. One or more of the components of the example system 400 may be included in RF processing circuitry of a wireless device. For example, referring to FIG. 1, the example system 400 may be implemented in the Bluetooth circuitry 108. In some cases, at least some of the antennas 401, LNA 402, or both, may be implemented outside of the Bluetooth circuitry 108, as shown in FIG. 1.

Referring to FIG. 4, the example system 400 includes antennas 401, low noise amplifier (LNA) 402, RF analog circuitry 403, digital front-end circuitry 404, On/Off control circuitry 406, half band filter (HBF0) 408A and HBF1 408B, and GFSK Detector (GDET) 410.

The system 400 may include additional or fewer components than those shown, in some embodiments. Although on/off control circuitry 406 is shown in FIG. 4 as a distinct/dedicated component, it could, according to some embodiments, include circuitry in any processor within a system device, such as for example circuitry that is at least partially part of an application processor, such as processor 104 of FIG. 1.

The RF analog circuitry 403 and the digital front-end circuitry 404 may be referred to as receiver circuitry 405. In some cases, the system 400 may include an external low noise amplifier (eLNA) such as LNA 402. The eLNA may work in lieu of a LNA within the RF analog circuitry 403, or may work in conjunction with a LNA in the RF analog circuitry 403. The RF analog circuitry 403 may include circuitry for processing RF signals received by the antennas 401. For example, the RF analog circuitry 403 may include one or more of an amplifier (e.g., a low noise amplifier (LNA)), a filter, an automatic gain control (AGC) feedback loop, an RF peak detector, analog mixer, or another type of circuitry for analog processing of the RF signals. For example, the RF analog circuitry 403 may convert a received RF signal into the IF band and translate it to a digital signal. The digital front-end circuitry 404 may include circuitry for digitally processing the signals received by the antennas 401 and processed by the RF analog circuitry 403. For example, the digital front-end circuitry 404 may handle a sampling rate change, carrier frequency offset removal, or out-of-band interference suppression. The digital front-end circuitry 404 outputs an 8 MHz signal, which in some cases, may comprise in-phase and quadrature signals (I and Q signals). The digital front-end circuitry 404 may be implemented by a digital signal processing (DSP) apparatus in some instances.

The GDET 410 operates on the output of the digital front-end circuitry 404 during the On-period to detect if a wireless signal of interest (e.g., a GFSK signal) exists at the receiver circuitry 405 based on detecting underlying phase properties or characteristics of GFSK-modulated signals that are used in BT, and generates a detection signal, referred to herein as the slotted window expired signal 430, based on an analysis of phase properties. The On/Off control circuitry 406 coupled to the GDET 410 and the receiver circuitry 405 is configured to switch the receiver circuitry 405 between On-periods and Off-periods based on the detection signal. That is the On/Off control circuitry 406 is configured to turn off the receiver circuitry for an off-period in response to the detection signal indicating that the wireless signal does not comprise the GFSK property to save power consumption, and to maintain the receiver circuitry 405 in the On-period when the detection signal indicates that the wireless signal does comprises the GFSK property.

In one example embodiment, the On/Off control circuitry 406 may turn off the receiver circuitry for an Off-period in response to receiving the detection signal, indicating that the wireless signal does not comprise the GFSK property, to save power consumption, and may maintain the receiver circuitry 405 in the On-period when the detection signal is not received, indicating that the wireless signal does comprises the GFSK property.

In an alternative embodiment, the detection signal may be configured to have the opposite effect, such that the On/Off control circuitry 406 maintains the receiver circuitry 405 in the On-period when the detection signal is received, and turns off the receiver circuitry 405 when the detection signal is not received. In yet another embodiment, the GDET 410 may send the detection signal with a value indicating classification of the signal as a GFSK signal (receiver kept on) or a non-GFSK signal (receiver turned off).

However, to improve the robustness of the GDET 410, the 8 MHz signal output by the receiver circuitry 405 is first processed by the down sampling blocks HBF0 408A and HBF1 408B to generate two internal filtered signals having different sampling rates—a 4 MHz signal and a 2 MHz signal. The HBF0 408A reduces the sampling rate of the receiver circuitry 405 output signal from 8 MHz to a 4 MHz sampling rate signal by down sampling the receiver output to an over sampling ratio (OSR) of 4. The 4 MHz signal output by the HBF0 408A is input to both the HBF1 1408B and the GDET 410. The HBF1 408B reduces the 4 MHz signal to a 2 MHz sampling rate signal by down sampling the 4 MHz signal to an OSR of 2.

According to one aspect, the GDET 410 may be configured to process the two signals from HBF0 and HBF1 to decide whether the input signal is a GFSK signal or not. Accordingly, the GDET 410 may be implemented as two GFSK detectors, GDET0 and GDET1, with GDET0 processing the HBF0 4 MHz signal output by HBF0 and GDET1 processing the HBF1 2 MHz signal output by HBF1.

The HBF0 4 MHz signal has very good phase difference properties, facilitating classification of the signal as GFSK or non-GFSK based on the variance of their differential phases. The HBF1 2 MHz signal, by contrast, may have a slightly degraded phase difference properties with respect to the HBF0 signal, but due to its lower bandwidth (i.e., lower frequency range) compared to the the HBF0 signals, the HBF1 signal rejects strong adjacent interferes that might have smooth phase and could potentially trigger the GDET1 analyzing the HBF0 signal, causing a false alarm. The final detector decision is given by an AND 429 between the decisions of each of the GFSK detectors processing the HBF0 and HBF1 signals.

GDET1 and GDET2 share the same implementation and are configured to perform the same digital signal processing. Components of GDET1 and GDET2 may comprise a phase calculator referred to as a COordinate Rotation DIgital Computer (Cordic) 419, phase buffer 420, phase difference analyzer 422, and phase variance estimator 424 in some embodiments. GDET 410 or another component of system 400, may further include a detector (DET) controller 426.

To calculate the phase difference variance of the HBF0 and HBF1 signals, GDET0 and GDET1 use cordic 418 to calculate instantaneous phases of the HBF0 and HBF1 signals, respectively. The phases from cordic 418 are input into phase buffer 420 to store a history of the phases so that metrics on phase behavior may be calculated. In some implementations, the phase buffer 420 of GDET0 that processes the HBF0 signal may be set to 128 samples to allow the accumulation of the entire advertiser address in BLE, which is 32 μs long, at an Over Sampling Ratio (OSR) of 4. In some implementations, the phase buffer of GDET1 that processes the HBF1 signal may be set to 64 samples deep, due to working at OSR of 2.

The phase difference analyzer 422 retrieves pairs of consecutive phase samples from the phase buffer 420 and calculates a differential phase (i.e., phase differences) between each pair of consecutive phase samples. The phase variance estimator 424 receives the differential phases output by the phase difference analyzer 422 and calculates a variance of the differential phases. In other words, the phase variance estimator 424 determines a variance of the phase differences 425.

Each of two DET controllers 426 receives the variance of the phase differences 425 from either GDET0 and GDET1, and compares this variation metric to the varied thresholds. In an alternative embodiment, a single DET controller 426 could be used instead of two. Based on the characteristics of GFSK modulation, the phases of Bluetooth signals tend to be very smooth and change very slowly. If the phases are tracked and the variance or difference between the consecutive phases examined, smooth behavior of the phases is expected, meaning that the variance of the phase differences is very low and a low variance metric is produced. On the other hand, if the input signal is a Wi-Fi signal or noise or any signal other than a Bluetooth signal, the examination of the variation is expected to produce a high variance metric.

Each DET controller 426 compares the variation metric from either GDET0 and GDET1 indicating the variance of the phase differences 425 to one or more variation thresholds 428. When the variance metric is above one or more variation thresholds 428, then the DET controller 426 outputs a signal classification 427 indicating that the input signal represents noise or otherwise a non-GFSK signal. If the variance metric is below the one or more variation thresholds 428, then the DET controller 426 outputs a signal classification 427 indicating that the input signal represents a GFSK or BT signal.

The final GDET 410 decision is given by an AND 429 between the signal classifications 427 output by the two DET controllers 426 indicating whether or not the HBF0 and HBF1 signals represent a GFSK or BT signal. In one embodiment, if both the HBF0 and HBF1 signals have been classified as a GFSK signal, the DET controller 426 is configured to hold the receiver circuitry 405 in the on-period by not transmitting the “slotted window expired signal” 430 so that the system 400 can receive and process additional packet data. If even one of the HBF0 and HBF1 signals has been classified as a non-GFSK signal, the DET controller 426 commands the On/Off controller 406 to turn-off the receiver circuitry 405 by transmitting the “slotted window expired signal” 430. Also, once a slotted window time expires without detecting a valid BT signal (see FIG. 5, block 524), the DET controller 426 sends the slotted window expired signal 430 to turn off the receiver circuitry 405.

In one embodiment, there may be three windows of time during which the DET controller 426 compares the variance of the phase difference to the one or more variation thresholds 428. To keep the receive circuitry 405 to receive the whole packet, the comparison is performed three times in three separate time windows, window 1, window 2, and window 3 using three separate variation thresholds-variation threshold 1, variation threshold 2, and variation threshold 3. In each of those windows, the DET controller 426 compares the variance of the phase differences to the corresponding variation threshold. If, and only if, that variance is below the threshold defined for each of the windows 1-3, do the checkpoints pass and the receiver circuitry 405 remains in the On-period to receive the signal. If even one of the windows expires or fails to pass, the DET controller 426 commands the On/Off controller to turn the receiver circuitry 405 Off via a “slotted window expired” signal 430.

The on/off control circuitry 406 includes circuitry to switch the RF analog circuitry 403, digital front-end circuitry 404, or both (synchronously) between an On-period and an Off-period according to a time-slotted scheme as described herein. For example, the on/off control circuitry 406 may duty cycle the RF analog circuitry 403 and the digital front-end circuitry 404 between on and Off-periods (i.e., periods of time when the RF analog circuitry 403 is powered and not powered, respectively). The on/off control circuitry 406 may indicate the on- or Off-period to the circuitries 403, 404 via an ON/OFF control signal 432. Most of the power savings in the time-slotted scheme may be achieved from not powering the RF analog circuitry 403 or the digital front-end circuitry 404 during the Off-period. In some embodiments, an external component to the system 400, e.g., an external low noise amplifier (eLNA) may be powered off during the Off-period as well.

In some embodiments, the on/off control circuitry 406 may be enabled or turned on by an rx_on signal, which may be generated by firmware coupled to the system 400. When in the On-period, the RF analog circuitry 403 and digital front-end circuitry 404 may process signals received by the antennas 401, and may pass such signals to the GDET 410.

Although not shown, the system 400 further includes demodulation circuitry to process additional signals of the packet received by the receiver circuitry when held in the On-period.

The dual GFSK detector approach has several advantages. For example, by processing two internal input signals from the DFE, and using a detector with many Degrees of Freedom (DOF), it has been shown that sweet spots exist such that on the one hand the GFSK detector may save on average more than half of the scan power, and on the other hand, the GFSK detector should rarely miss a packet, which results with comparable PER curves to the existing, high power consuming receivers which are turned on for the entire scan time.

Referring now to FIG. 5, a diagram of an example slotted Rx state machine 500 for use in the system 400 will be described.

In certain aspects, a duty cycle for the slotted operation must be configured. In one example, a duty cycle of 6 μs On and 6 μs Off (50% On-Off) may be set. This means that the On/Off control circuitry 406 powers on (block 502) the receiver circuitry 405 during an On-period 503 and powers off (block 504) the receiver circuitry 405 during an Off-period 505. The GDET 410 (via the DET controller 426) is responsible for sending the “slotted window expired” signal 430 (block 528) to the On/Off control circuitry 406 when the required window has expired or when a non-GFSK signal is detected. The On/Off control circuitry 406 turns off the receiver circuitry 405 upon receiving this signal and will reopen it again after the next Off-period 505.

Note that part of the On-period 503 is not accessible to the GDET 410 due to a wakeup time. To accommodate RF and other analog components'wakeup time, the GDET 410 is activated after a configurable delay from power ON, denoted by “start delay” period (block 506). A typical start delay may be ~2 μs, consisting of LNA wakeup time (0.5 μs) and analog baseband filter group delay (1 μs), for example.

Immediately after the start delay period (block 506), both GDET0 and GDET1 begin measuring the phase difference variance on both HBF0 and HBF1 signals, respectively. After a configurable time interval, denoted by “check point 0 ” (block 508), the phase difference variance metrics calculated by GDET0 and GDET1 are compared to variance threshold 0. It will be appreciated that the three variance thresholds defined for GDET0 corresponding to each of the three time windows may have different values than the three variance thresholds defined for GDET1.

If it is determined that both phase difference variance metrics are below their respective variance threshold 0 values (block 510), then the receiver circuitry 405 remains in the On-period 503, and continues to measure the phase difference variances for another interval of time, until “check point 1” (block 512) is reached.

The metrics of both GDET0 and GDET1 are again compared to a different set of thresholds-variance threshold 1. If it is determined that both phase difference variance metrics are also below their variance threshold 1 values (block 514), GDET0 and GDET1 continue to measure their phase difference variance metrics for a third and last interval, ending at “check point 2” (block 516).

If check point 2 passes successfully (i.e., both phase difference variance metrics are also below their variance threshold 2 values (block 518), the receiver circuitry 405 remains in the On-period 503. The GDET 410 then attempts to synchronize on the access address 214 or sync word 224 in the received packet (block 520) and determines if sync is found or a sync timer expires (block 522). If the synch is found, then demodulation of the signal may begin (block 526). If the synch is not found, the receiver circuitry 405 remains in the On-period 503 until the sync is found or the sync timer expires (block 524). If any of the variance metrics are above any of the variance thresholds or the sync timer expires (block 524), the slotted window expired signal is sent.

More specifically, if at any of the check points, either of GDET0 and GDET1 do not detect a valid GFSK signal, the “slotted window expired” signal 430 is triggered and sent to the On/Off control circuitry 406 (block 528), causing the receiver circuitry 405 to shut down. After the Off-period 504, the On/Off control circuitry 406 powers on the receiver circuitry 405 once again, and the entire flow begins, starting from another start delay period.

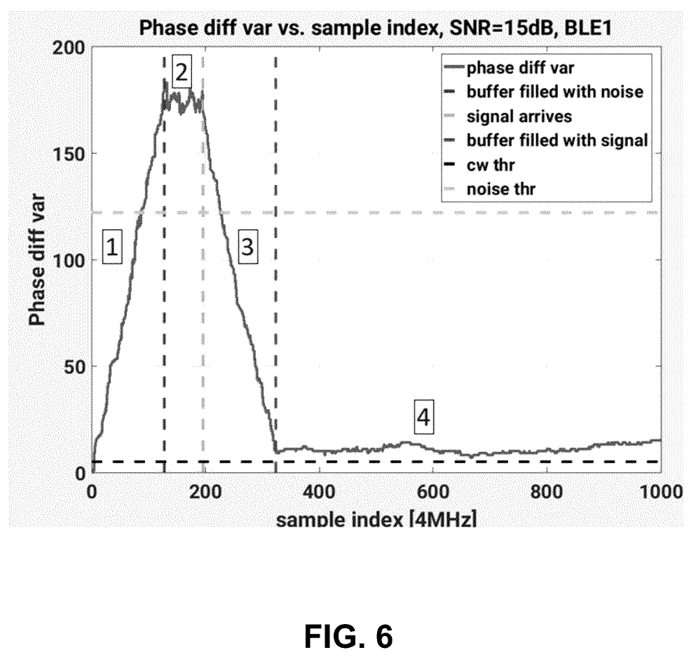

FIG. 6 illustrates a graph showing the phase difference variance versus sample index for a signal-to-noise ratio (SNR) of 15 dB of the HBF0 signal, calculated over the full 32 μs phase buffer 420. The dark line shows the calculated phase difference variance metric plotted against sample index values ranging from 0 to 1000 at a 4 MHz sampling rate. The graph is divided into four distinct areas, marked numerically. In area “1”, an increase is shown in the metric as the phase difference buffer is filled with noise samples. In area “2”, the phase difference buffer is full, and for every new sample that is inserted into the buffer, an old sample is ejected from the buffer, and the phase difference metric corresponding to the current state of the buffer is calculated. Area 2 maintains a steady variance level. In area “3” In region 3, the arrival of the signal causes low phase-difference variance samples to replace noise samples, leading to a decrease in overall variance. In area “4”, the buffer is filled with valid BT signals, resulting in a very low phase difference variance, as expected. The significant gap between the plateau lines in areas “2” and “4” illustrates that in steady state, when the buffer is full, the phase difference variance metric can be used as a reliable indicator for the presence of a BT signal.

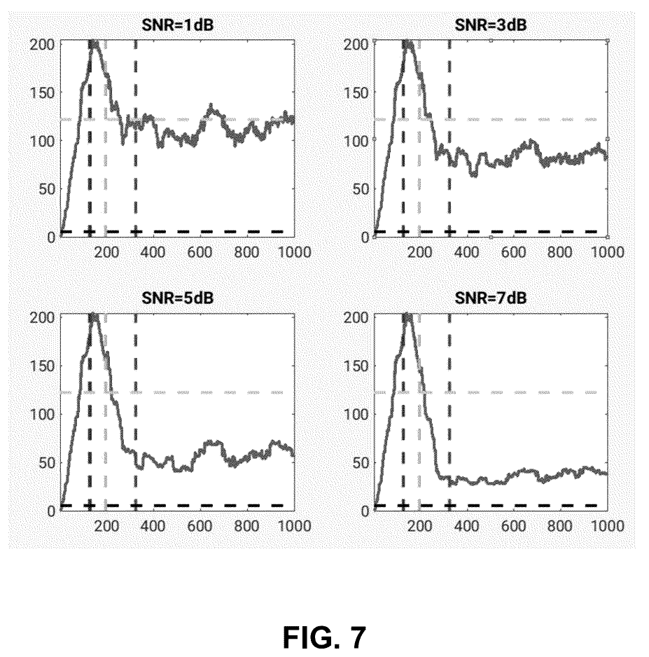

One of the challenges to implementing the slotted Rx scan is implementing a detector that identifies a GFSK signal as early as possible, with a sufficiently low False Alarm (FA) and Miss Detection (MD) probabilities. As SNR decreases, the gap between the noise only and noise plus signal metrics decreases, as shown in FIG. 7.

FIG. 7 shows a graph of phase difference variance versus sample index, in different Signal to Noise (SNR) ratios, according to an embodiment. To find the optimal thresholds for detection of the GFSK signal in HBF0 and HBF1 signals, the statistics of their corresponding metrics have been collected for multiple SNRs of 1 dB, 3 dB, 5 dB, and 7 dB. Each graph plots a dark signal line against a light blue dashed threshold line over a range from 0 to 1000 on the x-axis and 0 to 200 on the y-axis. The graphs illustrate how signal behavior changes with increasing SNR, with the dark signal line showing less variance and better separation from the threshold line at higher SNR values.

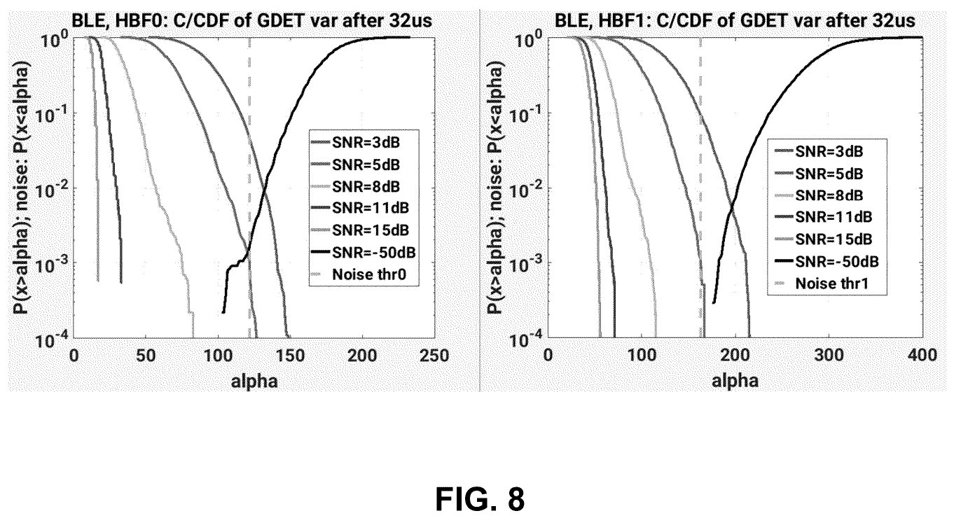

FIG. 8 depicts the Cumulative Distribution Function (CDF) curves for Gaussian Frequency Shift Keying (GFSK) variance metrics at different signal-to-noise ratios (SNR). The left graph displays the CDF curves for HBF0 signal, while the right graph shows the CDF curves for HBF1 signal. Each graph includes multiple curves representing different SNR values ranging from 3 dB to 15 dB, as well as a −50 dB noise reference curve. A vertical dashed line in each graph indicates the chosen threshold used to distinguish between signal at 5 dB SNR and noise only (SNR=−50 dB), with the left graph showing “Noise thr0” and the right graph showing “Noise thr1”. The y-axis represents probability on a logarithmic scale from 10⁻⁴ to 10⁰, while the x-axis represents a parameter measuring phase difference variance (denoted by alpha). As depicted, targeting an SNR of 5 dB, thresholds of 120 and 160 for the HBF0 and HBF1 signals, respectively, provides a good tradeoff between FA and MD.

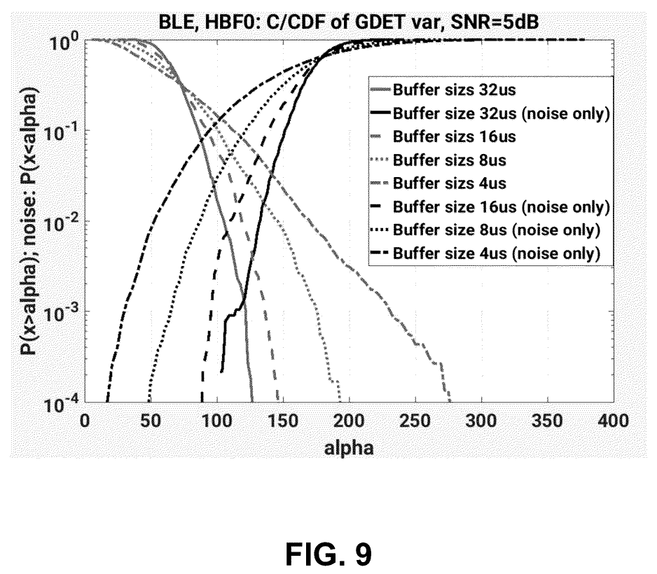

FIG. 9 illustrates a graph showing cumulative distribution functions (CCDF) of GFSK detector variance metrics for different buffer sizes at a signal-to-noise ratio (SNR) of 5 dB for HBF0 signal. The graph includes multiple curves representing buffer sizes of 32 μs, 16 μs, 8 μs, and 4 μs, with each buffer size having two curves—one for the complete signal and one for noise-only conditions. The y-axis shows probability values on a logarithmic scale from 10⁻⁴ to 10⁰, while the x-axis shows the values of the phase difference variance metric ranging from 0 to 400. The curves demonstrate how the variance metrics distribute differently between noise-only and signal-present conditions across different buffer sizes, with larger separations between the curves indicating better discrimination capability.

Using these figures, the thresholds for all checkpoints may be determined. Using a Dynamic Moving Average Mechanism (DMAM), the phase difference variance can be accurately calculated for all check points. This mechanism counts the number of samples that were received so far, and updates the division factor to match the number of received samples, such that its output metric is a reliable estimate of the biased sample variance estimation (assuming zero expectation). Check points that are located at the end of intervals with a length that is a power of two, will have an accurate estimate of the phase difference variance (since low-cost shifters are used as divisions). Other check points will have an estimation that is biased towards zero (as the division of the accumulated squared phase difference will be done with a factor that is given by the next power of two that follows the check point length).

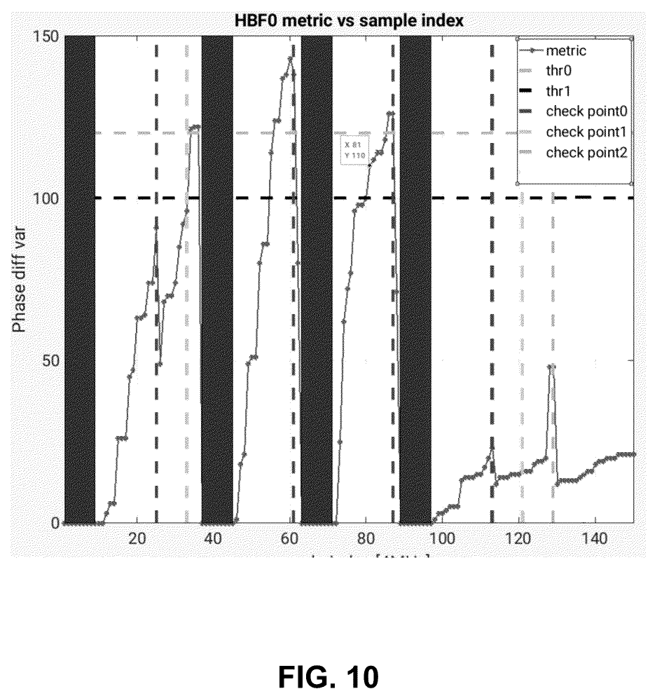

FIG. 10 depicts a graph showing the phase difference variance metric values in the slotted Rx scan flow for the HBF0 signal plotted against a sample index. The y-axis represents phase difference variance values ranging from 0 to 150. The x-axis shows example HBF0 sample index values from 0 to approximately 140 at a 4 MHz sampling rate. The phase difference variance metric values are shown a dark plotted line that fluctuates, along with threshold indicators including a dashed horizontal line labeled “thr0” and a dashed horizontal line labeled “thr1”. Several vertical dashed lines in different colors represent check points, labeled as “check point0”, “check point1”, and “check point2”. The shaded vertical bands represent “start delay” periods, during which the GDET 410 is inactive and the HBF0 metric is zero. The phase difference variance metric values show distinct patterns of rising and falling between the shaded start delay periods, with notable peaks reaching near the thr0 threshold.

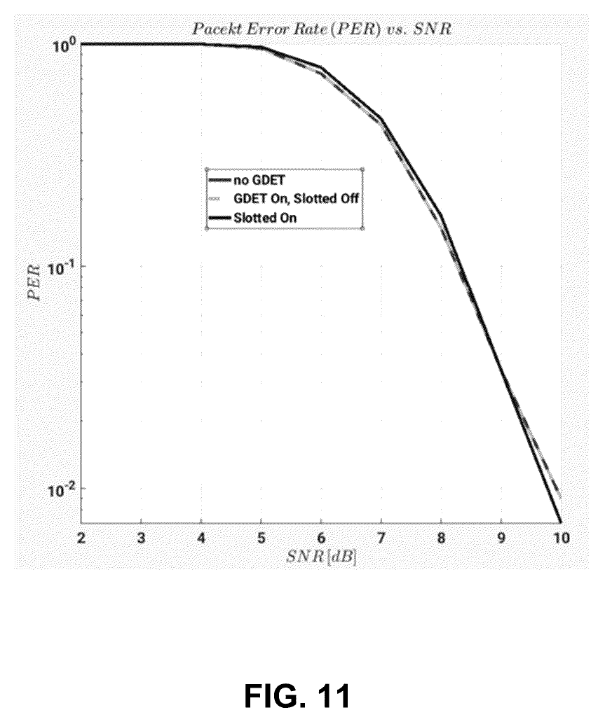

FIG. 11 presents a graph showing BLE packet error rate (PER) versus signal-to-noise ratio (SNR) performance curves for different receiver configurations, according to an embodiment. The graph displays three curves representing different operating modes: no GFSK detector (GDET), GDET On with Slotted Off, and GDET with Slotted On. The x-axis shows SNR values ranging from 2 to 10 dB, while the y-axis shows PER values on a scale from 10⁻² to 10⁰. The three curves track closely together, demonstrating similar performance across the SNR range, with PER decreasing as SNR increases. The curves show minimal divergence between the different operating modes, particularly in the SNR range between 5 and 8 dB where the PER drops most significantly.

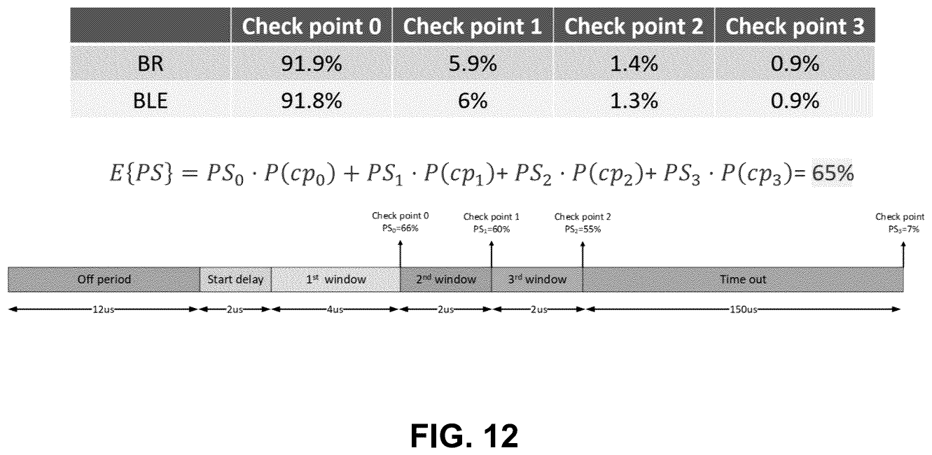

FIG. 12 depicts a table and graph showing checkpoint statistics of expected power saving using the slotted Rx scan operation. By gathering statistics over the duration of the On-periods in noise only scenarios, the expected power saving using the slotted Rx operation can be calculated. The table displays the probability of correctly detecting a non-GFSK signal at different checkpoints for both Basic Rate (BR) and Bluetooth Low Energy (BLE) signals, with checkpoint 0 showing approximately 92% detection, checkpoint 1 showing approximately 6% detection, checkpoint 2 showing approximately 1.4% detection, and checkpoint 3 showing approximately 0.9% detection. Below the table, a mathematical equation that calculates overall expected power savings.

Below the table, a mathematical equation calculates the expected power savings, resulting in 65%. The lower portion of the figure shows a timeline diagram illustrating different operational periods including an off-period, start delay, first window, second window, third window, and time out period, with their respective durations marked in microseconds. The timeline also indicates checkpoint locations and their corresponding power save percentages. It can be see that for ~92% of the cases, the slotted Rx scan algorithm will correctly identify the input noise as a non-GFSK signal after 6 μs (2 μs of start delay+4 μs of the first window), causing the Receiver to go to Off-period, which is set to 12 μs in this example (since the figures below that good PER at off-periods up to 12 μs can be obtained). Thus, in 92% of the cases, the slotted Rx scan algorithm will save 12 μs/18 μs=66% of the power. Similarly, the slotted Rx scan algorithm would save 60% and 55% of the power in case the input noise is correctly identified as noise after the second and third window, respectively. Only in ~1% of the cases, the noise will be falsely identified as a valid GFSK signal, resulting in a very low power save. The average power save would then be 65%, as shown in the equation.

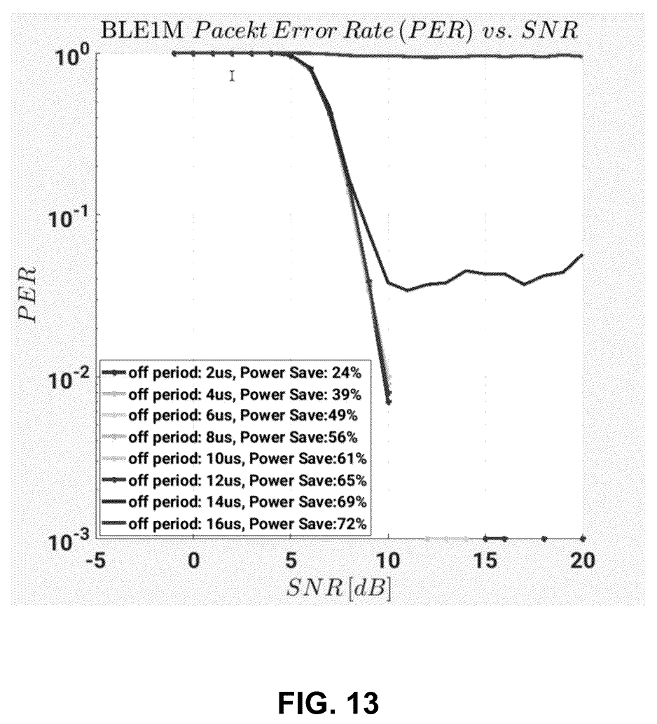

FIG. 13 depicts graphs showing packet error rate (PER) versus signal-to-noise ratio (SNR) for different off-periods in a Bluetooth Low Energy (BLE1M) system, along with the expected power save in each case, according to aspects of the present disclosure. The graph illustrates multiple curves representing various off-periods ranging from 2 microseconds to 16 microseconds, with corresponding power savings percentages from 24% to 72%. The x-axis represents the SNR in decibels (dB), while the y-axis shows the PER on a logarithmic scale. As the off-period increases from 2 to 16 microseconds, the power savings increase proportionally. All curves show similar PER performance until approximately 5 dB SNR, after which they begin to diverge. The graphs indicate that longer off-periods, up to an off period of 12 μs, may achieve higher power savings while maintaining acceptable PER performance above certain SNR thresholds. However, for off periods above 12 μs a PER floor starts to arise. This data may be useful for optimizing the trade-off between power savings and packet error rates in BLE systems implementing the slotted Rx scan technique.

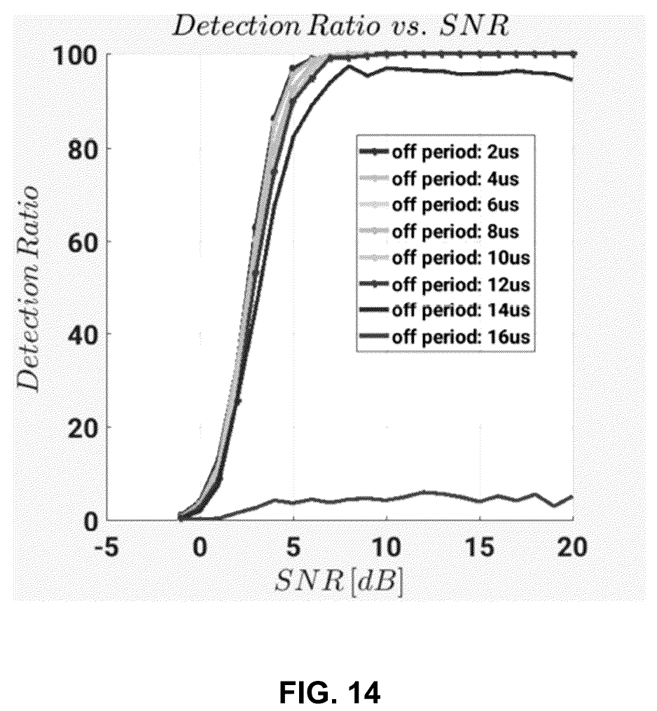

FIG. 14 depicts a graph showing detection ratio versus signal-to-noise ratio (SNR) performance for different off-periods in a wireless system, according to an embodiment. The graph displays multiple curves representing different off-periods ranging from 2 microseconds to 16 microseconds, with the detection ratio plotted on the y-axis from 0 to 100 and SNR plotted on the x-axis from −5 to 20 dB. The curves demonstrate similar behavior, starting near zero detection ratio at low SNR values and rapidly increasing between 0-5 dB SNR before leveling off at higher SNR values. The curves show slight variations in performance based on off-period duration, with shorter off-periods (2-12 microseconds) achieving higher detection ratios approaching 100% at high SNR values, while longer off-periods (14-16 microseconds) show somewhat reduced detection ratios even at high SNR values. This data may be used to analyze the trade-offs between detection performance and power savings for different off-period durations in the slotted Rx scan technique.

### EXAMPLES

Example 1: An apparatus, comprising: receiver circuitry configured to receive a wireless signal; a first filter configured to generate a first filtered signal from an output of the receiver circuitry; a second filter configured to generate a second filtered signal from the first filtered signal, the first filtered signal and the second filtered signal having different sampling rates; a Gaussian Frequency Shift Keying (GFSK) detector coupled to the first filter and the second filter; and control circuitry coupled to the GFSK detector and the receiver circuitry configured to switch the receiver circuitry between an on-period and an off-period based on an output from the first GFSK detector and the second GFSK detector.
Example 2: The apparatus of claim 1, wherein the GFSK detector is configured to: analyze a phase property of the wireless signal during the on-period to determine whether the wireless signal comprises a GFSK property; and generate a detection signal based on the analyzed phase property; and the control circuitry is configured to: maintain the receiver circuitry in the on-period in response to the detection signal indicating that the wireless signal comprises the GFSK property; and turn off the receiver circuitry for an off-period in response to the detection signal indicating that the wireless signal does not comprise the GFSK property.
Example 3: The apparatus of example 1 or some other example, wherein the control circuitry is configured to turn off the receiver circuitry for an off-period in response to the detection signal indicating that the wireless signal does not comprise the GFSK property.
Example 4: The apparatus of example 1 or some other example, wherein the GFSK detector is configured to classify the wireless signal as a Bluetooth signal responsive to determining the wireless signal comprises the GFSK property.
Example 5: The apparatus of example 1 or some other example, wherein the GFSK detector is configured to analyze as the GFSK property, phase differences between consecutive samples of the wireless signal.
Example 6: The apparatus of example 5 or some other example, wherein the GFSK detector comprises: a phase buffer configured to store a history of phase samples of the wireless signal; a phase difference analyzer configured to calculate phase differences between consecutive phase samples stored in the phase buffer; and a phase variance estimator configured to calculate a variance of the phase differences.
Example 7: The apparatus of example 6 or some other example, wherein a detector controller is configured to compare the variance of the phase differences to one or more thresholds to detect presence of a GFSK-modulated signal.
Example 8: The apparatus of example 1 or some other example, wherein the GFSK detector is configured to analyze phase differences of the wireless signal during multiple time windows.
Example 9: The apparatus of example 8 or some other example, wherein the multiple time windows are associated with different variance thresholds, the GFSK detector configured to: in each of the multiple time windows, compare a variance metric of the wireless signal to the corresponding variation threshold; responsive to the variance metric being determined to be below each of the corresponding variance threshold defined for each of the multiple time windows, output a signal indication that the wireless signal represents a GFSK signal such that the receiver circuitry remains in an on-period to receive the wireless signal; and when the variance metric is determined to be above any of the corresponding variation thresholds defined for the multiple time windows, output a signal indication that the wireless signal represents a non-GFSK signal, such that the receiver circuitry is turned off for an off-period.
Example 10: A system, comprising: receiver circuitry configured to receive a wireless signal; a first filter configured to generate a first filtered signal from the received wireless signals; a second filter configured to generate a second filtered signal from the first filtered signal, the first filtered signal and the second filtered signal having different sampling rates; a first Gaussian Frequency Shift Keying (GFSK) detector configured to analyze phase properties of the first filtered signal; a second GFSK detector configured to analyze phase properties of the second filtered signal; and control circuitry configured to: determine whether to switch the receiver circuitry between an On-period and an Off-period based on whether outputs from the first GFSK detector and the second GFSK detector indicate the wireless signal comprises a GFSK-modulated signal or a non-GFSK-modulated signal, respectively.
Example 11: The system of example 10 or some other example, wherein the first filter is configured to reduce a sampling rate of the wireless signal from 8 MHz to 4 MHz.
Example 12: The system of example 11 or some other example, wherein the second filter is configured to reduce the sampling rate of the first filtered signal from 4 MHz to 2 MHz.
Example 13: The system of example 10 or some other example, wherein each of the first GFSK detector and the second GFSK detector comprises: a phase calculator configured to calculate instantaneous phases of the respective filtered signal; a phase buffer configured to store a history of the calculated phases; a phase difference analyzer configured to calculate differential phases between consecutive stored phases; and a variance estimator configured to determine a variance of the differential phases.
Example 14: The system of example 14 or some other example, wherein a detector controller configured to: compare the variance of the differential phases to one or more thresholds to detect presence of a GFSK-modulated signal; and indicate to the control circuitry to maintain the receiver circuitry in the On-period based on the comparison.
Example 15: The system of example 14 or some other example, wherein the control circuitry is configured to maintain the receiver circuitry in the On-period when the variance of the differential phases is below the one or more thresholds.
Example 16: The system of example 10 or some other example, wherein the control circuitry is configured to switch the receiver circuitry between the On-period and the Off-period according to a duty cycle comprising an on-period of 3-6 microseconds and an off-period of 4-12 microseconds.
Example 17: The system of example 10 or some other example, wherein a detector controller is configured to analyze the phase differences of the first filtered signal and the second filtered signal during multiple time windows.
Example 18: The system of example 17 or some other example, wherein the multiple time windows are associated with different variance thresholds, the detector controller configured to: in each of the multiple time windows, compare a variance metric of the first filtered signal and the second filtered signal to a corresponding variation threshold; when the variance metric of both the first filtered signal and the second filtered signal are determined to be below each of the corresponding variation threshold defined for each of the multiple time windows, output a signal indication that the wireless signal represents a GFSK signal such that the receiver circuitry remains in the on-period to receive the wireless signal; and when the variance metric of either the first filtered signal or the second filtered signal is determined to be above any of the corresponding variation threshold defined for each of the multiple time windows, output a signal indication that the wireless signal represents a non-GFSK signal, such that the receiver circuitry is turned off for an off-period.
Example 19: A non-transitory computer-readable medium storing instructions that, when executed by a processor of a wireless device, cause the wireless device to perform operations comprising: controlling receiver circuitry to alternate between on-periods and off-periods; during an on-period, analyzing phase characteristics of a received wireless signal using a Gaussian Frequency Shift Keying (GFSK) detector; determining that the wireless signal comprises a GFSK-modulated signal based on the analyzed phase characteristics; maintaining the on-period of the receiver circuitry in response to determining presence of the GFSK signal; and switching to an off-period in response to determining presence of a non-GFSK signal.
Example 20: The non-transitory computer-readable medium of example 19, wherein analyzing the phase characteristics comprises: storing phase information of the wireless signal in a phase buffer; calculating phase differences between consecutive samples stored in the phase buffer; determining a variance of the calculated phase differences; and comparing the determined variance to one or more thresholds to detect presence of the GFSK-modulated signal.
Example 21: The non-transitory computer-readable medium of example 19 or some other example, further causing the wireless device to perform operations comprising: analyzing the phase differences of the wireless signal during multiple time windows.
Example Z01 may include an apparatus comprising means to perform one or more elements of a method described in or related to any of examples 1-21, or any other method or process described herein.
Example Z02 may include one or more non-transitory computer-readable media comprising instructions to cause an electronic device, upon execution of the instructions by one or more processors of the electronic device, to perform one or more elements of a method described in or related to any of examples 1-21, or any other method or process described herein.
Example Z03 may include an apparatus comprising logic, modules, or circuitry to perform one or more elements of a method described in or related to any of examples 1-21, or any other method or process described herein.
Example Z04 may include a method, technique, or process as described in or related to any of examples 1-21, or portions or parts thereof.
Example Z05 may include an apparatus comprising: one or more processors and one or more computer-readable media comprising instructions that, when executed by the one or more processors, cause the one or more processors to perform the method, techniques, or process as described in or related to any of examples 1-21, or portions thereof.
Example Z06 may include a signal as described in or related to any of examples 1-21, or portions or parts thereof.
Example Z07 may include a datagram, packet, frame, segment, protocol data unit (PDU), or message as described in or related to any of examples 1-21, or portions or parts thereof, or otherwise described in the present disclosure.
Example Z08 may include a signal encoded with data as described in or related to any of examples 1-21, or portions or parts thereof, or otherwise described in the present disclosure.
Example Z09 may include a signal encoded with a datagram, packet, frame, segment, protocol data unit (PDU), or message as described in or related to any of examples 1-21, or portions or parts thereof, or otherwise described in the present disclosure.
Example Z10 may include an electromagnetic signal carrying computer-readable instructions, wherein execution of the computer-readable instructions by one or more processors is to cause the one or more processors to perform the method, techniques, or process as described in or related to any of examples 1-21, or portions thereof.
Example Z11 may include a computer program comprising instructions, wherein execution of the program by a processing element is to cause the processing element to carry out the method, techniques, or process as described in or related to any of examples 1-21, or portions thereof.
Example Z12 may include a signal in a wireless network as shown and described herein.
Example Z13 may include a method of communicating in a wireless network as shown and described herein.
Example Z14 may include a system for providing wireless communication as shown and described herein.
Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. An apparatus, comprising:
receiver circuitry configured to receive a wireless signal;
a first filter configured to generate a first filtered signal from an output of the receiver circuitry;
a second filter configured to generate a second filtered signal from the first filtered signal, the first filtered signal and the second filtered signal having different sampling rates;
a Gaussian Frequency Shift Keying (GFSK) detector coupled to the first filter and the second filter; and
control circuitry coupled to the GFSK detector and the receiver circuitry configured to switch the receiver circuitry between an on-period and an off-period based on an output from the GFSK detector.

2. The apparatus of claim 1, wherein the GFSK detector is configured to: analyze a phase property of the wireless signal during the on-period to determine whether the wireless signal comprises a GFSK property; and generate a detection signal based on the analyzed phase property.

3. The apparatus of claim 1, wherein the GFSK detector is configured to classify the wireless signal as a Bluetooth signal responsive to determining the wireless signal comprises the GFSK property.

4. The apparatus of claim 1, wherein the GFSK detector is configured to analyze as the GFSK property, phase differences between consecutive samples of the wireless signal.

5. The apparatus of claim 4, wherein the GFSK detector comprises:
a phase buffer configured to store a history of phase samples of the wireless signal;
a phase difference analyzer configured to calculate phase differences between consecutive phase samples stored in the phase buffer; and
a phase variance estimator configured to calculate a variance of the phase differences.

6. The apparatus of claim 5, wherein a detector controller is configured to compare the variance of the phase differences to one or more thresholds to detect presence of a GFSK-modulated signal.

7. The apparatus of claim 1, wherein the GFSK detector is configured to analyze phase differences of the wireless signal during multiple time windows.

8. The apparatus of claim 7, wherein the multiple time windows are associated with different variance thresholds, the GFSK detector configured to:
in the multiple time windows, compare a variance metric of the wireless signal to the corresponding variation threshold;
responsive to the variance metric being determined to be below each of the corresponding variance threshold defined for each of the multiple time windows, output a signal indication that the wireless signal represents a GFSK signal such that the receiver circuitry remains in an on-period to receive the wireless signal; and
responsive to the variance metric being determined to be above any of the corresponding variation thresholds defined for the multiple time windows, output a signal indication that the wireless signal represents a non-GFSK signal, such that the receiver circuitry is turned off for an off-period.

9. A system, comprising:
receiver circuitry configured to receive a wireless signal;
a first filter configured to generate a first filtered signal from the received wireless signals;
a second filter configured to generate a second filtered signal from the first filtered signal, the first filtered signal and the second filtered signal having different sampling rates;
a first Gaussian Frequency Shift Keying (GFSK) detector configured to analyze phase properties of the first filtered signal;
a second GFSK detector configured to analyze phase properties of the second filtered signal; and
control circuitry configured to:
determine whether to switch the receiver circuitry between an on-period and an off-period based on whether outputs from the first GFSK detector and the second GFSK detector indicate the wireless signal comprises a GFSK-modulated signal or a non-GFSK-modulated signal, respectively.

10. The system of claim 9, wherein the first filter is configured to reduce a sampling rate of the wireless signal from 8 MHz to 4 MHz.

11. The system of claim 10, wherein the second filter is configured to reduce the sampling rate of the first filtered signal from 4 MHz to 2 MHz.

12. The system of claim 9, wherein each of the first GFSK detector and the second GFSK detector comprises:
a phase calculator configured to calculate phases of the respective filtered signal;
a phase buffer configured to store a history of the calculated phases;
a phase difference analyzer configured to calculate differential phases between consecutive stored phases; and
a variance estimator configured to determine a variance of the differential phases.

13. The system of claim 12, further comprising a detector controller configured to:
compare the variance of the differential phases to one or more thresholds to detect presence of a GFSK-modulated signal; and
indicate to the control circuitry to maintain the receiver circuitry in the on-period based on the comparison.

14. The system of claim 13, wherein the control circuitry is configured to maintain the receiver circuitry in the on-period when the variance of the differential phases is below the one or more thresholds.

15. The system of claim 9, wherein the control circuitry is configured to switch the receiver circuitry between the on-period and the off-period according to a duty cycle comprising an on-period of 3-6 microseconds and an off-period of 4-12 microseconds.

16. The system of claim 9, further comprising a detector controller configured to analyze the phase differences of the first filtered signal and the second filtered signal during multiple time windows.

17. The system of claim 16, wherein the multiple time windows are associated with different variance thresholds, the detector controller configured to:
in the multiple time windows, compare a variance metric of the first filtered signal and the second filtered signal to a corresponding variation threshold;
in response to the variance metric of both the first filtered signal and the second filtered signal being determined to be below each of the corresponding variation threshold defined for each of the multiple time windows, output a signal indication that the wireless signal represents a GFSK signal such that the receiver circuitry remains in the on-period to receive the wireless signal; and
in response to the variance metric of either the first filtered signal or the second filtered signal being determined to be above any of the corresponding variation threshold defined for each of the multiple time windows, output a signal indication that the wireless signal represents a non-GFSK signal, such that the receiver circuitry is turned off for an off-period.

18. A non-transitory computer-readable medium storing instructions that, when executed by a processor of a wireless device, cause the wireless device to perform operations comprising:
controlling receiver circuitry to alternate between on-periods and off-periods;
during an on-period, analyzing phase characteristics of a received wireless signal using a Gaussian Frequency Shift Keying (GFSK) detector;
determining that the wireless signal comprises a GFSK-modulated signal based on the analyzed phase characteristics;
maintaining the on-period of the receiver circuitry in response to determining presence of the GFSK-modulated signal; and
switching to an off-period in response to determining presence of a non-GFSK signal.

19. The non-transitory computer-readable medium of claim 18, wherein analyzing the phase characteristics comprises:
storing phase information of the wireless signal in a phase buffer;
calculating phase differences between consecutive samples stored in the phase buffer;
determining a variance of the calculated phase differences; and
comparing the determined variance to one or more thresholds to detect presence of the GFSK-modulated signal.

20. The non-transitory computer-readable medium of claim 18, further further comprising instructions that cause the wireless device to perform operations comprising: analyzing phase differences of the wireless signal during multiple time windows.
